(19) United States
(12) Patent Application Publication
(10) Pub. No.: US 2026/0154557 A1
(43) Pub. Date: Jun. 4, 2026

(54) METHOD AND SYSTEM FOR ENHANCING PERFORMANCE OF LARGE LANGUAGE MODELS USING QUANTUM CIRCUITS

(71) Applicant: MULTIVERSE COMPUTING S.L., Donostia-San Sebastián (ES)

(72) Inventors: Borja AIZPURUA, Donostia-San Sebastián (ES); Sukhbinder SINGH, Ontario (CA); Saeed S. JAHROMI, Donostia-San Sebastián (ES); Roman ORUS, Donostia-San Sebastián (ES)

(21) Appl. No.: 19/319,683

(22) Filed: Sep. 4, 2025

Related U.S. Application Data
(63) Continuation-in-part of application No. 18/944,603, filed on Nov. 12, 2024.

(30) Foreign Application Priority Data
Nov. 5, 2024 (EP) 24210818.1
Aug. 22, 2025 (WO) PCT/EP2025/073979

(51) Int. Cl. G06N 3/09; G06F 17/16; G06N 10/20; G06N 10/60

(52) U.S. Cl. CPC G06N 3/09; G06F 17/16; G06N 10/20; G06N 10/60

(57) ABSTRACT

The method enhances computational efficiency and performance of large language models (LLMs) through hybrid classical-quantum processing. The method involves a classical computer receiving an input for processing by a selected LLM comprising deep self-attention and multilayer perceptron layers and decomposing the LLM's weight matrices into a first Matrix Product Operator (MPO). The classical computer identifies one or more disentanglers which factorize the MPO into a non-unitary tensor network and a set of unitary subcomponents. The non-unitary tensor network enables compression by localizing quantum correlations. The unitary subcomponents correspond to first and second variational quantum circuits, configured to run sequentially on a quantum computer. The execution of the second quantum circuit is conditioned on both the measurements of the first quantum circuit and outputs from the tensor network, enabling enhanced correlation capture and efficient model representation.

### CROSS-REFERENCE TO RELATED APPLICATIONS

This application claims priority to and benefit of PCT International Application Number PCT/IB2024/000540 filed on 22 Oct. 2024, European Patent Application Number EP24210818.1 filed on 5 Nov. 2024 and is a continuation-in-part application of United States Patent and Trademark Office application Ser. No. 18/944,603 filed on 12 Nov. 2024.

### TECHNICAL FIELD OF THE INVENTION

The present disclosure relates to methods for improving the computational efficiency and performance of large language models (LLMs).

Specifically, but without limitation, the disclosure pertains to replacing classical self-attention and multilayer perceptron (MLP) layers with a combination of quantum circuits and tensor networks, for enhancing the performance of large language models (LLMs) by removing the entanglement from the tensor network while allowing the compression.

### BACKGROUND OF THE INVENTION

The Large language models (LLMs) have revolutionized the natural language processing (NLP)-NLPs are basically statical and programmed models with limited context awareness-, enabling advancements in tasks such as machine translation, text generation, and semantic analysis. In the state of the art, LLMs such as ChatGPT and LIaMA, have achieved remarkable advancements in the natural language processing (NLP) and generative artificial intelligence (AI). However, these models' immense size and complexity result in significant challenges, including high training and inference costs, substantial energy consumption, and limitations in deploying them on-site, especially in resource-constrained environments.

Increasing size and complexity of these models present significant challenges in computational efficiency, memory usage, and energy consumption. Existing model compression techniques, such as pruning, quantization, and low-rank approximation, have sought to reduce these demands. While these methods have shown some success, they primarily focus on reducing the number of neurons or the precision of the weights, which may not always be the most effective strategy for optimizing the model's overall efficiency.

Classical self-attention and MLP layers, essential to the operation of these models, exacerbate these issues, particularly when real-time processing is required or when operating in resource-constrained environments. However, the self-attention mechanisms and multilayer perceptron (MLP) layers within these models (classical LLMs) demand substantial computational power and memory resources, particularly as the model size and input data dimensions increase. This challenge is further exacerbated in scenarios requiring real-time processing or deployment in environments with constrained computational resources.

Moreover, classical computation methods often struggle to capture intricate dependencies in high-dimensional data efficiently. The current design of LLMs involves handling a large number of parameters, leading to increased energy consumption and longer training times, which are not only costly but also environmentally unsustainable. As industries seek more energy-efficient solutions to meet the demand for larger and more sophisticated language models, there is an urgent need for innovative approaches that can address these limitations without sacrificing performance.

Andrei Tormut Et Al. CompactifAl: Extreme Compression of Large Language Models using Quantum-Inspired Tensor Networks, arXiv preprint arXiv:2401.14109 (2024) explains a reducing cost of computational task of the LLMs. According to this method, a quantum inspired method compresses the trained LLMs and reduces the re-training costs. Tensor networks compress LLMs by focusing on their internal correlation structures. This publication focusses on optimizing classical architectures such as above mentioned LLMs, by using quantum-inspired tensor networks such as Matrix Product Operators.

U.S. Pat. No. 10,275,721B2 explains a quantum machine learning method and system. However, this system and method does not apply any layers of large language models (LLMs), specially there is no mention the hybrid approach that contain quantum circuits and tensor network structures which is compress the layer and the new architecture can be computed with classical digital computer and quantum systems together.

HARVEY CARYS ET AL., “Sequence Processing with Quantum-Inspired Tensor Networks,” Scientific Reports, Vol. 15, No. 1, 15 Aug. 2023, US, ISSN: 2045-2322, DOI: 10.1038/s41598-024-84295-2, presents an example of sequence processing using quantum tensor networks. The work focuses on quantum natural language processing (QNLP) tasks and demonstrates implementations of large-scale quantum tree tensor network models on quantum processors. So, it introduces syntactic and convolutional quantum tensor network architectures supported by tensor trees which are mostly better suited for non-language data such as DNA sequences or MNIST images where syntax doesn't apply. However, our method and system introduce a hybrid structure that combines two quantum circuits—used for two layers of a large language model (LLM)—with a matrix product operator (MPO)-based tensor network. This hybrid design leverages the strengths of both tensor networks and quantum processors, enhancing both accuracy and computational speed. It achieves this by decomposing weight matrices using tensor network disentanglers and MPOs. Thus, it provides for removing the entanglement from the TN structured MPO, which provides increased accuracy for the LLM. Additionally, the method increases the bond dimensions of MPOs, enabling the model to capture richer correlations within the quantum-enhanced LLM.

As a result, all the problems listed above require innovation in the relevant field.

### SUMMARY

The present disclosure addresses abovementioned challenges and to make a development in the relevant technical field.

This disclosure offers a new pathway to enhancing the performance of LLMs through quantum circuits, leading to significant improvements in accuracy and efficiency for natural language processing tasks.

The main objective of the disclosure is the introduction of quantum circuits into the architecture of LLMs, bringing several notable performance improvements such as increasing the accuracy, reduced energy consumption, faster training and inference and scalability. Also, the disclosure provides more efficient and scalable AI systems.

Another object of the disclosure is to enhance the accuracy of LLMs while simultaneously reducing the computational and energy burdens associated with training and inference, enabling more scalable and sustainable LLM solutions. To provide this, it aims to improve the accuracy of Large Language Model (LLM) tasks by removing the entanglement from the first MPO while significantly reducing energy consumption, leveraging quantum computing's superior capabilities in managing complex optimization problems within reduced-dimensional spaces by transforming and optimizing the self-attention and multilayer perceptron (MLP) layers of LLMs. Especially, transforming these layers to quantum circuits concatenated with tensor networks as a replacement of classical weight matrices.

Another objective of the present disclosure is to refine the Matrix Product Operator (MPO) layer of a trained tensor network-based neural network, by embedding it into a disentangled structure amenable to quantum execution. The refinement aims to approximate the original weight matrix—expressed as an MPO—by restructuring it into a form that is sandwiched between two sequences of local unitary transformations. This transformation involves at least two quantum execution steps. The quantum circuits applied in this process serve to disentangle the tensor network, thereby enabling its efficient realization on quantum hardware.

Another objective of the present disclosure is enabling resource-efficient quantum execution by isolating entanglement-intensive components into variational circuits while offloading compressible substructures to classical simulation, thereby optimizing gate complexity and execution depth on Noisy Intermediate-Scale Quantum (NISQ) hardware.

Another objective of the disclosure, to provide computational efficiency and performance improvements in large-scale language models.

Another objective of the disclosure, improving scalability, allowing for the handling of larger models and datasets without incurring prohibitive computational costs.

Another objective of the disclosure, reducing the memory usage of at least one layer of the LLMs due to the truncation of the bond dimension, which effectively discards irrelevant parameters.

Another objective of the disclosure, establishing the integration of classical large language models in quantum circuits using a combination of disentangling operations followed by a tensor network, such as a Matrix Product Operator.

The disclosure is related to method and system for enhancing performance of large language models using quantum circuits to fulfil one, some or all aims mentioned above and will be obtained from the following detailed description. The disclosure is also related to: data processing systems with means for carrying out the methods; computer program products comprising instructions which, when the program products are executed by at least one computing unit, cause the at least one computing unit to carry out the methods; and computer-readable data carrier having stored thereon the computer program products, which may be computer-readable non-transitory storage mediums in some examples.

In accordance with embodiments, a method for improving the computational efficiency and performance of large language models (LLMs) and their tasks by at least one classical computer and at least one quantum computer, wherein the classical computer is configured to receive a pre-selected large language model (LLM) comprising self-attention layers and multilayer perceptron (MLP) layers that are deep layers of the large language model (LLM) including weight matrices; and wherein the large language model (LLM) is decomposed into a Matrix Product Operator (MPO) in a memory medium of the classical computer C); the method comprising: determining, by the classical computer, disentanglers of the MPO decomposition of the weight matrix by splitting the MPO into a non-unitary tensor network, and first and second (two) unitary variational quantum circuits of disentanglers, one of which acts as an input and the other one as an output of the non-unitary tensor network, each comprising a plurality of qubits, wherein first and second (two) unitary variational quantum circuits each composed of two-body unitary gates configured to remove entanglement from the MPO; and storing, by the classical computer, the two unitary variational quantum circuits, and the non-unitary tensor network that corresponds to a non-disentangled part of the MPO in the memory medium as a hybrid operator; mapping, by the classical computer, an input data received for LLM tasks into matrix product state (MPS); and encoding the matrix product state (MPS) of the inputs into a first encoding circuit for initializing the qubits; applying, by the classical computer, the first unitary variational quantum circuit using the first encoding circuit to apply quantum states of the inputs onto the first unitary variational quantum circuit; sending, by the classical computer, the first unitary variational quantum circuit with the first encoding circuit as quantum state of the inputs to the quantum computer; manipulating the qubits, by the quantum computer, by applying/executing the first unitary variational quantum circuits with the first encoding circuit, and measuring superpositions and entangled states of the qubits multiple times to provide first sampling results of the quantum state vector to the classical computer; applying the first sampling results of the quantum state to the non-unitary tensor network; and constructing a second encoding circuit from the non-unitary tensor network with the first sampling results; sending, by the classical computer, the second encoding circuit and the second unitary variational quantum circuit to the quantum computer; and manipulating the qubits, by the quantum computer, by applying/executing the second variational quantum circuit with the second encoding circuit; and measuring superpositions and entangled states of the qubits multiple times to provide second sampling results of the quantum state vector to the classical computer; decoding, by the classical computer, the results of second sampling to provide output of the LLM task.

In accordance with further embodiments, the method further comprising configuring the classical computer to obtain the first Matrix Product Operator by performing a singular value decomposition (SVD) on the weight matrix of the large language model (LLM) and truncating the bond dimension by retaining a subset of dominant singular values, wherein a truncated result is becomes a compressed Matrix Product Operator with reduced bond dimension.

In accordance with further embodiments, the method further comprising configuring the classical computer to determine the non-unitary tensor network, first and second unitary variational quantum circuits through the splitting step by approximating the first Matrix Product Operator, referred to as MPO_{old}, stored in the memory medium, by encoding it between two sequences of unitary transformations comprising at least two-qubit gates; through a decomposition into:

$${MPO}_{old} \approx U \times {MPO}_{new} \times {V}^{†} ,$$

wherein U and V^{†} are sequences of local unitary transformations implemented as the first and second unitary variational quantum circuits, respectively, and wherein MPO_{new} is a compressed non-unitary tensor network having a reduced bond dimension, representing a disentangled part of the first Matrix Product Operator. In accordance with further embodiments, optimization of the first and second unitary variational quantum circuits is performed based on a cost function defined by the normalized overlap between the first MPO and a reconstructed model comprising the first unitary variational quantum circuits, the non-unitary tensor network, and second unitary variational quantum circuits, respectively.

In accordance with further embodiments, the quantum computer is configured to optimizing at least one of the first and second unitary variational quantum circuits by a Variational Quantum Eigensolver (VQE) algorithm, wherein a set of variational parameters associated with the first and second unitary variational quantum circuits is iteratively updated to minimize a predefined cost function corresponding to a target observable or model reconstruction error, ensuring that the resulting model outperforms the accuracy of an original network layer of the large language model.

In accordance with further embodiments, the first and second unitary variational quantum circuits are optimized to minimize quantum entanglement across the non-unitary tensor network by iteratively adjusting gate parameters using a gradient-based optimization algorithm, wherein the gradients are computed using a parameter-shift rule or finite-difference method.

In accordance with further embodiments, the output of the quantum circuits is obtained through sampling via qubit measurements. Sampling step during the first and second quantum execution step comprises measuring the qubits at the output of at least one of the first or second unitary variational quantum circuits multiple times in the computational basis and aggregating the resulting measurement outcomes to construct a probability distribution representative of the quantum state.

In accordance with further embodiments, the number of repeated qubit measurements is selected to achieve a predefined statistical confidence level in the estimated probability distribution, wherein the confidence level being determined, by the classical computer, based on at least one of:
(a) a target fidelity threshold, or
(b) a task-specific accuracy requirement for the large language model (LLM) output.

In accordance with further embodiments, sampling of the first and second quantum execution step performed by the quantum computer comprises measuring the quantum state output by following steps:
executing quantum measurements on transpiled the first or second unitary variational quantum circuit to generate measurement counts;
normalizing the measurement counts into a probability distribution;
converting each probability into corresponding amplitude components of a reconstructed state vector by calculating square roots of the probabilities;
normalizing the reconstructed state vector;
scaling the normalized state vector by a predetermined factor; and
trimming the scaled state vector to retain a predefined number of amplitudes.

In accordance with further embodiments, sampling of the first and second quantum execution step performed by the quantum computer, configured to increase accuracy by performing the following steps:
converting weight parameters from tensor format to numerical arrays;
assigning these numerical arrays to parameters of an ansatz circuit to form a parameterized quantum circuit layer;
integrating the parameterized quantum circuit layer into a quantum circuit; and
performing transpilation comprising decomposition of circuit gates, applying backend-specific optimizations, and setting a predetermined transpilation seed for consistency.

In accordance with further embodiments of the method, the decoding step includes applying quantum state tomography, by the classical computer, to the results which are retrieved from quantum computer to extracting meaningful information from the quantum state that represents dominant contribution.

In accordance with further embodiments, the method further comprising; optimization step variationally to further refine the quantum gates and the tensors of the tensor networks to enlarging the number of layers in the first and second unitary quantum circuits, and enlarging the bond dimension of the tensor network after the first and second unitary quantum circuits, and non-unitary tensor network obtained, ensuring that the resulting model outperforms the accuracy of an original network layer of the large language model.

In accordance with further embodiments, the method is provided by a computer program product comprising instructions which, when the program is executed by the classical computer to provide a configuration to the quantum computer by first and second unitary quantum circuits, first and second encoding circuit to carry out.

In a preferred embodiment of the disclosure, the method applies disentanglers directly to the tensor network decomposition of classical neural network weight matrices of pre-selected LLM(s), particularly the self-attention and multilayer perceptron (MLP) components of transformers and it transforms them into quantum circuits followed by a non-unitary tensor network, which are optimized using variational parameters to efficiently capture high-dimensional dependencies.

In a preferred embodiment of the disclosure, all the initial tensor network decompositions of weight matrices are given by Matrix Product Operators.

In preferred embodiment of the disclosure, the new Matrix Product Operator can be further disentangled by a quantum circuits, and the remaining operator can also be stored as Matrix Product Operator format. When implemented on a quantum computer (QLLM), the input to the quantum circuits must be computed via quantum state encoding, and the output must be estimated via sampling. Allowing for more layers in the quantum circuits and for larger bond dimensions in the remaining Matrix Product Operator enhances the model beyond the capabilities of the original one.

In accordance with further embodiments, the method characterized by translating the non-unitary part of the weight matrix into a tensor network, which in some specific embodiments can be a Matrix Product Operator (MPO), for ensuring that accurately replication the behavior of the original network layer. The first unitary variational quantum circuits processes input quantum states, and the second unitary variational quantum circuits processes output quantum states of the non-unitary tensor network to executing disentangled part of the Matrix Product Operator (MPO).

In accordance with further embodiments of the method, classical computer employes tensorization step to the non-unitary part of the weight matrix to reduce the bond dimension and simplifying the structure for more efficient representation. Tensorization can be usable to estimate the level of entanglement (and therefore quantum resources estimation) and optimize components of the non-unitary part.

In accordance with further embodiments, the classical computer is further configured to converting an input data for the LLM tasks into matrix product state and encoding the matrix product state of the inputs to a first encoding circuit for initializing the qubits of the first unitary variational quantum circuit.

In accordance with further embodiments, the method characterized by increasing the number of layers of the quantum circuits of disentanglers and applying variational optimization techniques to further refine the quantum gates after the unitary quantum circuits and input data are encoded in the quantum computer to provide fine-tuned parameters of the quantum circuits ensuring that the quantum circuits improve the performance of the original network layer.

In accordance with further embodiments, the classical computing device further configured to creating hybrid model structure from the quantum state vectors of the self-attention and the multilayer perceptron layers and the non-unitary tensor network that cleaned from entanglement by classical computer.

In an alternative embodiment of the method, it provides improved performance in tensor network algorithms, where lowering the bond dimension is crucial for scalability. Thus, provided by the combined effect of the disentanglers and the reduced-dimension MPO offer an efficient representation of the original matrix, capturing its essential features while minimizing the computational complexity typically associated with high bond dimensions.

In accordance with further embodiments of the method, quantum variational algorithm in Variational Quantum Eigensolver (VQE) algorithm employed to find the optimal parameters of the quantum circuits that maximize the performance of the model.

In accordance with further embodiments of the method, the classical computer encodes the input data which consists of classical vectors into the quantum states with normalizing each input vector. In some embodiments, this encoding can be implemented using quantum Generative Adversarial Networks. In other embodiments, this encoding can be implemented using Tensor Network methods.

In accordance with further embodiments of the method, classical computer applies transpose of the unitary operator into the quantum state.

In accordance with further embodiments of the method, classical computer multiplies the final quantum state vector with the tensor network obtained from tensor network optimization of the non-unitary part pf the weight matrix. Also, classical computer converts the results to tensor structure for further processing in the neural network.

In accordance with further embodiments, the system comprises the quantum (computer) that manipulates the qubits with applying/executing the quantum circuits that provided from the classical computer; and sends the obtained results to the classical computer.

In preferred embodiment of the disclosure, the method provides handling complex optimization problems, the quantum circuits provide more accurate representations of high-dimensional dependencies in data. This results in a model that outperforms classical LLMs in terms of accuracy, especially on complex natural language processing tasks.

In preferred embodiment of the disclosure, the method provides inherently more efficient LLMs at processing high-dimensional data. By replacing computationally heavy classical layers with quantum circuits and tensor networks, the hybrid model achieves significant reductions in energy consumption during both training and inference, making it more sustainable.

In preferred embodiment of the disclosure, the method provides potential for faster processing as quantum technologies mature, while current implementations rely on simulators due to the noise and limitations of NISQ-era quantum hardware. Quantum circuits, in principle, offer advantages through parallelism and the ability to handle high-dimensional spaces more efficiently than classical methods. As quantum hardware continues to improve, the model is expected to benefit from reduced training times and faster inference, paving the way for real-time deployment in the future.

In preferred embodiment of the disclosure, the method ensures that it can be scaled up for larger datasets and more complex tasks without suffering from the same computational bottlenecks that plague classical models.

The protection scope of the disclosure is specified in the claims and cannot be limited to the description made for illustrative purposes in this brief and detailed description. It is clear that a person skilled in the art can present similar embodiments in the light of the above and following descriptions without departing from the main theme of the disclosure.

### BRIEF DESCRIPTION OF DRAWINGS

For better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teaching described herein.

FIG. 1A represents a large language model architecture for some embodiments of the disclosure.

FIG. 1B represents a quantum large language model architecture for some embodiments of the disclosure.

FIG. 2A represents a linear layer of an LLM model.

FIG. 2B represents the decomposition of the weights of the linear layer in terms of a unitary quantum circuits of disentanglers followed by a non-unitary tensor network.

FIG. 3 represents some embodiments of the system.

FIG. 4 shows a schematic flow chart for some embodiment of the disclosure.

FIG. 5 illustrates in a flowchart that shows the steps of a method in accordance with some embodiments of the disclosure.

FIG. 6 shows an embodiment of an encoding circuit that encodes the LLM input data for the quantum circuits.

For a better understanding of the above-mentioned figures, the reference numbers illustrated in the figures are provided for descriptive purposes and are not intended to limit the scope of the disclosure.

### DETAILED DESCRIPTION OF THE INVENTION

In this detailed description, method and system(S) for enhancing performance of large language models using quantum circuits is described by means of examples only for clarifying the subject matter without any limitation of the scope of the disclosure.

A method for improving the computational efficiency and performance of large language models (LLMs) by at least one classical computer (C) and at least one quantum computer (Q); the method comprising: receiving, by the classical computer (C), an LLM input data, and a pre-selected large language model (LLM), which is stored in a memory medium (20), comprising self-attention layers and multilayer perceptron (MLP) layers that are deep layers of the large language model (LLM) including at least one weight matrices; wherein the deep layers of the large language model (LLM) are decomposed into a first Matrix Product Operator in a memory medium (20) of the classical computer (C); determining, by the classical computer (C), one or more disentanglers configured to factorize a first Matrix Product Operator (MPO) of the weight matrix into: (i) a non-unitary tensor network (22) to capture correlations between subsets of tensor components and allow classical simulation and compression by reducing entanglement redundancy and localizing quantum correlations; and (ii) a set of unitary subcomponents comprising a first and second variational quantum circuit (211, 212), each comprising a plurality of qubits, and configured to execute on the quantum computer (Q) by mapping the decomposed subspaces into hardware-efficient quantum gates; wherein first and second variational quantum circuits (211, 212) configured to execute on the quantum computer (Q) in two different quantum execution steps, while execution of the second variational quantum circuit (212) depends on both measurement results of the first variational quantum circuit (211) and the output of the non-unitary tensor network (22).

The method, further comprises: storing, by the classical computer (C), the first and second unitary variational quantum circuits (211, 212) and the non-unitary tensor network (22) in the memory medium (20); mapping, by the classical computer (C), input data received for the LLM input data into a matrix product state (MPS), and encoding the matrix product state (MPS) into a first encoding circuit (231) for initializing the qubits; transpiling, by the classical computer (C), the first unitary variational quantum circuit (211) configured with the first encoding circuit (231), into a hardware-executable gate sequence by obtaining a transpiled first circuit (241); sending, by the classical computer (C), the transpiled first circuit (241) to the quantum computer (Q); executing, by the quantum computer (Q), the first transpiled circuit (241) to manipulate the qubits, and measuring superpositions and entangled states of the qubits multiple times to provide first sampling results of a quantum state from a first quantum execution step; applying, by the classical computer (C), the first sampling results of the first quantum execution step to the non-unitary tensor network (22), and constructing a second encoding circuit (232) based on the non-unitary tensor network (22) and the first sampling results; transpiling the second unitary variational quantum circuit (212), configured with the second encoding circuit (232), into a hardware-executable gate sequence, obtaining a transpiled second circuit (242); sending, by the classical computer (C), the transpiled second circuit (242) to the quantum computer (Q); executing, by the quantum computer (Q), the second transpiled circuit (242) to manipulate the qubits, and measuring superpositions and entangled states of the qubits multiple times to provide second sampling results from a second quantum execution step; decoding, by the classical computer (C), the second sampling results to provide output corresponding to the LLM input data.

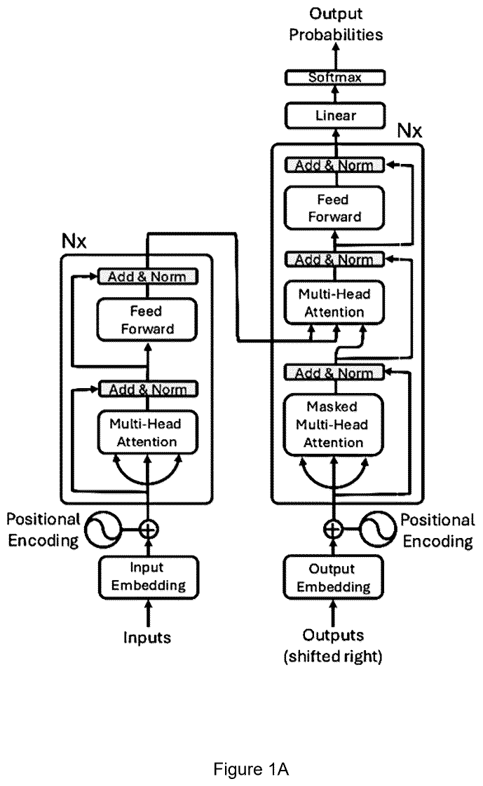

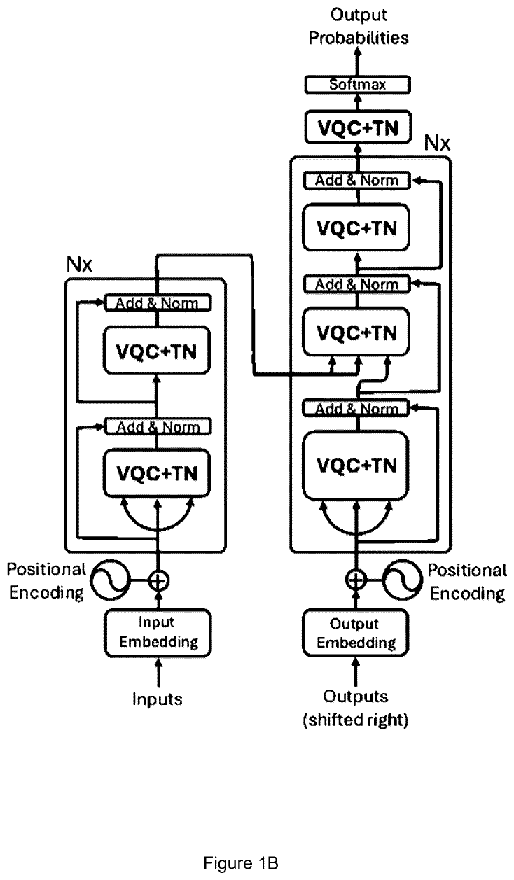

FIG. 1A represents a large language model architecture and FIG. 1B represents a quantum large language model (qLLM) architecture for some embodiments of the disclosure. According to the implementation of the disclosure, where layers of the large language model (LLM) architecture that involve weight matrices have been replaced by two variational quantum circuits (21) combined with a non-unitary tensor network (22). The method includes applying disentanglers to decompose the weight matrix into at least one as preferred two unitary quantum circuit (21) which are first unitary variational quantum circuit (211) and second unitary variational quantum circuit (212), and a non-unitary tensor network (22). The result of this structure (hybrid operator) provides a product of the unitary quantum circuits (21) and a non-unitary tensor network (22) of a complex weight matrix W.

According to the method, a first Matrix Product Operator (MPO) decomposition to weight matrix is performed and the bond dimension χ of the Matrix Product Operator (MPO) is truncated in order to preserve the model's accuracy. This step reveals the relevant correlations between the degrees of freedom in a layer. As a result, the memory usage of that layer is reduced due to the truncation of the bond dimension χ, which effectively discards irrelevant parameters that do not contribute significantly to the model's performance.

In preferred embodiment of the disclosure, a computing unit (10) of the classical computer (C) is configured to identifying layers of the LLM with the weight matrices, decomposing the weight matrices of the LLM into a tensor network. This step rewrites the weight matrix W in a format that explicitly reveals the relevant correlations between the degrees of freedom in the layer into a memory medium (20). As a result, the memory usage of that layer is reduced due to the truncation of the bond dimension χ, which effectively discards irrelevant parameters.

A classical computer (C) is configured to construct of two quantum circuits (21) of disentanglers for the Matrix Product Operator (MPO). Since the Matrix Product Operator (MPO) is an operator stored in the memory medium (20). The first unitary quantum circuit (211) is acting on the input, and the second unitary quantum circuit (212) is acting on the output of the non-unitary tensor network (22). The computation of disentanglers is well-established with MPO decomposition.

According to the method, computation of the quantum circuits of disentanglers for the Matrix Product Operator (MPO) established by a quantum computer (Q). According to the embodiment, the quantum computer (Q) computes two quantum circuits (21) of disentanglers, for the Matrix Product Operator (MPO), one by one including a communication with the classical computer (C) that one for the input and one for the output of the hybrid operator. Specifically, computation of two circuits composed of two-body unitary gates that remove as much entanglement as can be managed from the Matrix Product Operator (MPO) of weight matrix W. The computation of disentanglers is a well-established procedure in the field of tensor networks, forming the core of techniques such as Entanglement Renormalization (ER) and the Multiscale Entanglement Renormalization Ansatz (MERA). The disentanglers can be computed efficiently using iterative methods. The process continues until most (all as preferred) of the entanglement is removed from the Matrix Product Operator (MPO), resulting in two unitary disentangling quantum circuits (21).

Computation of a new Matrix Product Operator (MPO) by the classical computer (C) representing the remaining part of the original Matrix Product Operator (MPO) that is non-unitary tensor network (22) and cannot be disentangled. This process is described by the equation MPO_{old}=U×MPO_{new}×V^{†}, where old Matrix Product Operator (MPO_{old}) is the original Matrix Product Operator (MPO) decomposition of the weight matrix W, (Since MPO_{old} is not necessarily Hermitian, we have that U≠V in general) the new Matrix Product Operator (MPO_{new}) is the “remaining” Matrix Product Operator (MPO), and U and V^{†} are the unitary quantum circuits (21) of disentanglers. The unitary quantum circuits (21) remove entanglement from the first Matrix Product Operator (MPOold), and the bond dimension of new Matrix Product Operator (MPOnew) is lower than that of first Matrix Product Operator (MPOold). The new Matrix Product Operator (MPOnew), can be computed as MPO_{new}=U^{†}×MPO_{old}×V. This computation can be efficiently carried out using standard tensor network approximation techniques, such as the Time-Evolving Block Decimation (TEBD) algorithm within the classical computer (C).

In another embodiment of the disclosure, the quantum circuits (21) can be obtained, such as using the polar decomposition W=U×P of the weight matrix, where U is unitary and P is positive-definite, are also possible. Unitary matrix U can be directly mapped to the quantum circuits (21) since quantum operations are inherently unitary. Thus, provides decomposition unitary matrix into a sequence of quantum gates that can be implemented on quantum hardware. In preferred embodiment, the quantum circuits (21) involve one and two qubit gates following well-established quantum operator techniques. These gates perform the necessary transformations on quantum states while maintaining the unitary nature of the operations, ensuring the integrity of the quantum computation. Transforming unitary matrix U into quantum circuits (21) established by representing unitary matrix as a quantum operator which decomposed into sequence of quantum gates that are compatible with the target quantum hardware.

In a preferred embodiment, the optimization of the first and second unitary variational quantum circuits (211, 212) is obtained by the classical computer (C) using a cost function defined as a normalized overlap metric. Specifically, the classical computer (C) configured to compute the trace-based overlap between the first Matrix Product Operator and a reconstructed MPO (hybrid operator) composed of the quantum circuits (21), which are the first unitary variational quantum circuit (211), the second unitary variational quantum circuit (212), and the non-unitary tensor network (22). The cost function is defined to be sensitive to both the fidelity of reconstruction and the norm deviation between the first and reconstructed MPOs. This normalized cost function provides a robust optimization criterion for minimizing the discrepancy between the input MPO and the non-unitary tensor network (22), and the second unitary variational quantum circuit (212) model thereby guiding the variational adjustment of the unitary circuits to achieve an accurate compressed transformation.

$$C = 1 - \frac{Tr [ {MPO}_{old}^{†} \cdot ( U \cdot {MPO}_{new} \cdot {V}^{†} ]}{‖ {MPO}_{old} ‖ \cdot ‖ U \cdot {MPO}_{new} \cdot {V}^{†} ‖}$$

In a preferred embodiment, each unitary gate {Uᵢ} and {Vᵢ} is updated iteratively.

Construction of the quantum operators established by transpose of the unitary matrix (U^{T}). The quantum circuits (21) operate with U|ψ> however classical data corresponds to <ψ|U.

After the transposition process, the quantum circuits (21) transpiled to optimization for the target quantum backend. In this process available gate sets, qubit connectivity, and optimization levels considered. Thus, ensures that the quantum circuits (21) are both efficient and executable on the chosen quantum hardware.

In an alternative embodiment, the method comprises an optimization step in which the classical computer (C) generates a parameterized quantum circuit (21) designed to implement a hardware-efficient ansatz. This ansatz is optimized with respect to the architecture of a target Noisy Intermediate-Scale Quantum (NISQ) processor, and is specifically adapted to its qubit connectivity topology, native gate set, and prevailing noise characteristics. By aligning the variational circuit structure with the physical and operational constraints of the target hardware, the optimization step enhances the performance and expressiveness of at least one of quantum circuits (21), thereby facilitating more effective variational training and execution on noisy quantum devices (computer (Q)).

In an alternative embodiment, following the generation and execution of the parameterized quantum circuit, the method further comprises processing, by the classical compute (C), the measurement results received from the quantum computer (Q) to compute an estimate of the system's energy, such as the expectation value of a Hamiltonian operator. The classical computer (C) then performs an optimization step wherein the parameters of the quantum circuits (21) are updated using a classical optimization algorithm configured to minimize the computed energy estimate. This hybrid optimization loop explicitly accounts for quantum hardware limitations, including qubit noise and decoherence effects, by integrating hardware-aware error mitigation strategies or noise-informed cost evaluations. The quantum circuit execution and classical optimization steps are iteratively repeated until a convergence criterion is met—such as a threshold in energy change or a maximum number of iterations—thereby yielding an optimized quantum state approximating the ground state of the target system.

Second Matrix Product Operator (MPOnew), retains the scaling properties of weight matrix. However, it tends to exhibit lower entanglement compared to the weight matrix due to the removal of the unitary component. This reduction on entanglement makes it more efficient for classical processing with the classical computer (C), benefiting from reduced entanglement and lower computational complexity.

The method includes tensorization of the new Matrix Product Operator (MPOnew), which is non-unitary tensor network (22). The method leverages the application of two-qubit disentangler unitary operators, which are designed to systematically remove entanglement between adjacent qubits, thereby reducing the bond dimension in a controlled manner. According to the embodiment, method applies a sequence of two-qubit disentangler unitaries at various points in the tensor network. These disentanglers act locally to decouple or disentangle neighboring qubits, minimizing the amount of quantum correlations that contribute to the overall bond dimension. By applying this series of disentangling transformations, significant reduction occurs in the bond dimension, making the resulting tensor network representation more efficient. At the end of the disentangling process, the final structure consists of two components which one is unitary disentangler which are providing with applying a series of unitary operators to reduce the entanglement between qubits; and remaining part, that is non-unitary tensor network (22) (MPOnew), with a significantly reduced bond dimension of the first Matrix Product Operator (MPOold) which captures the remaining correlations that could not be eliminated by the disentangling unitaries.

To providing the method, the classical computer (C) is configured to apply disentanglers to decompose the weight matrices into: (i) first and second unitary variational quantum circuits (211, 212), each comprising a plurality of qubits and corresponding to the unitary component of the weight matrices; and (ii) a non-unitary tensor network representing the residual correlations. The unitary part of the weight matrices is converted into quantum gates, and both the quantum circuits (21), which are first and second unitary variational quantum circuits (211, 212) and the non-unitary tensor network (22) are stored in a storage unit (20) as a hybrid operator. This operator is optimized to remove entanglement from the Matrix Product Operator (MPO) by disentanglers, which are first unitary variational quantum circuit (211) and second unitary variational quantum circuit (212), facilitating accuracy of the Large Language Model (LLM). The hybrid model encapsulates both classical and quantum representations to enable efficient integration within the LLM framework.

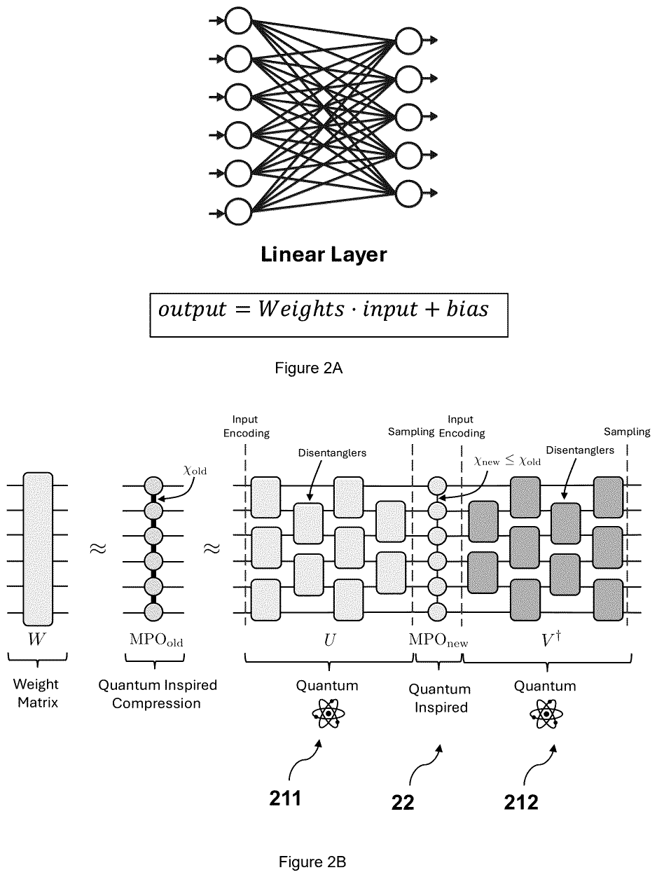

FIG. 2B shows integration of the disentangler approach into large language models (LLMs), showing how the unitary matrix is processed on quantum circuits (21), and the non-unitary tensor network (22) is processed with at least one classical computer (C). The process is demonstrated in the context of a transformer architecture, with the potential implementation. The figure also highlights the potential implementation of this approach in transformer architectures, with indicating the possible use of quantum hardware for certain computations.

In the quantum data processing step, quantum state preparation involves converting input data for the LLM tasks—consisting of classical vectors—into quantum states formatted as a matrix product state (MPS). The classical computing device (C) encodes the resulting MPS into a first encoding circuit (231) used to initialize the qubits of the first unitary variational quantum circuit (211). In some embodiments, this encoding can be implemented using quantum Generative Adversarial Networks. In other embodiments, this encoding can be implemented using Tensor Network methods.

In a preferred embodiment, the classical computer (C) is configured to apply the first encoding circuit (231) to the first unitary variational quantum circuits (211) by applying the transpose of a unitary matrix (operator) to the quantum state, thereby enabling reverse encoding aligned with variational gate application.

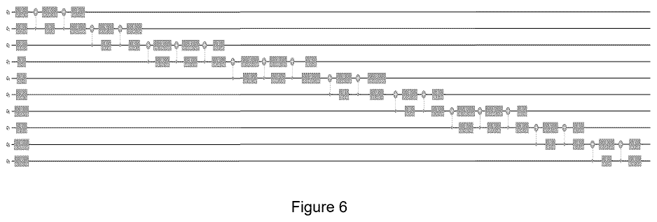

In a preferred embodiment, as shown in FIG. 6, the first encoding circuit (231) comprises a set of quantum registers-preferably 10 qubits- and, each of them initialized and rotated using parameterized single-qubit gates U(θ, φ, λ), where the parameters are derived from classical data inputs, which are LLM input data. The first encoding circuit (231) controlled by NOT gates (CNOTs) interleaved between adjacent qubits to introduce entanglement. A multi-block structure to allow sequential and layered data encoding, facilitating representation of high-dimensional classical inputs such as tensors. Each U gate rotation corresponds to a transformation of the qubit's state on the Bloch sphere, enabling expressive embedding of classical numerical values. CNOT gates propagate quantum correlations across the register, enhancing the circuit's representational power for quantum algorithms such as quantum variational circuits or quantum-enhanced neural layers.

In a preferred embodiment of the disclosure, to initializing the qubits, encoding circuits (23), which are first and second encoding circuits (231, 232), are obtained by the classical computer (C) as following:
Extract and normalize input data:
   Select the first entry from input data.
   Calculate and apply normalization factor.
Select measurement basis:
   If no interactions are defined:
      Calculate total measurements regarding to qubit count.
      Determine number of measurements based on measurement rate.
      Randomly sample basis indices from all possible combinations.
   If interactions are defined:
      Generate basis indices using interaction rules.
Initialize quantum circuit:
   If Matrix Product State (MPS) initialization is enabled:
      Reshape input into tensor form.
   Perform singular value decomposition iteratively per qubit.
   Scale and store decomposed tensors in MPS format.
   Normalize, compress, and convert MPS to sequential quantum circuit.
Else:
   Directly initialize quantum circuit with normalized input data.
Output prepared quantum circuit and selected measurement basis indices.

The classical computer (C) is further configured to encode the matrix product state resulting from the non-unitary tensor network (22) and the sampling results of quantum state retrained from the first unitary variational quantum circuit (211) into a second encoding circuit (232). The second encoding circuit (232) serves as a downstream interface for subsequent quantum processing step with second unitary variational quantum circuit (212). The quantum states of the second quantum processing step, which employed by the quantum computer (Q), sampled to retrieving final LLM results to the classical computer (C).

In a preferred embodiment of the disclosure, manipulating the qubits accomplished by the quantum computer (Q) by executing the first and second unitary variational quantum circuit (212, 212) with the first and second encoding circuit (231, 232), and measuring superpositions and entangled states of the qubits multiple times to provide the first and second sampling results of the first and second quantum execution step. The method and a computer program product comprising instructions which, when the program is executed by the classical computer (C) and/or by the quantum computer (Q) further characterized by following steps:
If Sampling is Enabled:
   Copy transpiled quantum circuit to create a sampled circuit.
   Apply measurement operations to all qubits.
   Execute circuit on quantum backend with predefined shots.
   Obtain and convert measurement results to a counts distribution.
   Normalize measurement counts to compute probabilities.
   Initialize state vector (zero-filled) based on qubit count.
   For each measurement outcome:
      Calculate vector index from bitstring.
      Assign amplitude as square root of probability.
   Normalize the constructed state vector.
   Scale normalized vector with a predefined factor.
   Trim resulting state vector to desired dimension.
If Sampling is Not Enabled (State Tomography):
   Initialize State Tomography with transpiled circuit and selected basis indices.
   Execute tomography with defined shots and fixed seed.
   Extract density matrix from tomography results.
   Compute eigenvalues and eigenvectors of density matrix.
   Select eigenvector corresponding to maximum eigenvalue and normalize it.
   Extract real component of normalized eigenvector to recover classical data.
   Scale classical data by predefined factor.
   Identify index with maximum amplitude:
      Compare signs of amplitudes at maximum amplitude index between recovered data and original input.
      If signs differ, invert sign of recovered data.
   Trim recovered data to desired dimension (preferably 576 amplitudes).

Regarding to these steps; classical computer (C) is configured to establish following steps:

```
IF sampling_enabled THEN
  COPY quantum_circuit_transpiled INTO qc_sample
  APPLY measurement operations TO all qubits IN qc_sample
  RUN qc_sample ON quantum_backend WITH defined_shots
  OBTAIN measurement_results FROM execution
  CONVERT measurement_results TO counts_distribution
  CALCULATE total_measurements AS sum OF counts_distribution.values
  COMPUTE probabilities FOR each measurement outcome IN counts_distribution
  BY normalizing with total_measurements
  INITIALIZE zero_vector OF length (2\hat{ }num_qubits)
  FOR each bitstring AND probability IN probabilities DO
  CALCULATE index FROM bitstring (binary to decimal)
  ASSIGN amplitude IN zero_vector AT index AS sqrt(probability)
  NORMALIZE zero_vector TO unit_length
  SCALE normalized_vector WITH predefined norm_factor
  TRIM resultant_statevector TO required dimension
ELSE
  INITIALIZE State_Tomography WITH quantum_circuit_transpiled AND
  selected_basis_indices
  EXECUTE State_Tomography ON quantum_backend WITH fixed_seed AND
  defined_shots
  OBTAIN tomography_results
  EXTRACT density_matrix FROM tomography_results
  COMPUTE eigenvalues AND eigenvectors OF density_matrix
  IDENTIFY eigenvector_corresponding_to_maximum_eigenvalue
  NORMALIZE identified_eigenvector
  RECOVER classical_data BY extracting real_component OF
  normalized_eigenvector
  SCALE classical_data WITH predefined norm_factor
  IDENTIFY maximum_amplitude_index IN recovered_data
  COMPUTE signs FOR both reconstructed AND original_input amplitudes AT
  maximum_amplitude_index
  IF signs differ THEN
  INVERT reconstructed_data_sign
  TRIM reconstructed_data TO required dimension (first 576 amplitudes)
ENDIF
```

In a preferred embodiment of the disclosure, quantum state tomography is employed to reconstruct quantum states from measurement data. This process enables the extraction of the density matrix and the corresponding quantum state vectors that are necessary for subsequent computations and system characterization.

Due to the exponential scaling of required measurements, a selected subset of measurement bases is used to reduce computational overhead while maintaining acceptable accuracy. From the reconstructed quantum state, the quantum computer (Q) computes the most probable computational basis states, enabling efficient estimation of output distributions for LLM tasks.

In a preferred embodiment of the disclosure, the quantum circuits (21) executed on the quantum computer (Q) are transpiled into a hardware-specific form using a transpiler that decomposes abstract gates into native instruction sets compatible with the target quantum hardware. The number of repeated quantum measurements (shots) is selected dynamically based on a statistical confidence threshold, defined by a fidelity or task-specific accuracy requirement. This ensures the resulting quantum state approximations are sufficiently accurate for classical post-processing and maintains robustness on NISQ hardware. Sampling is performed multiple times per circuit, and classical post-processing reconstructs a probability distribution or state vector for use in downstream tasks such as model inference or decoding.

In a preferred embodiment of the disclosure, the method includes a variational quantum layer integrated into the classical neural network model that provides more robust hybrid architecture. This architecture enables fine-tuning of parameters associated with the quantum circuits (21) in order to minimize a task-specific loss function. Parameterized quantum gates, such as rotation gates and entangling gates with adjustable angles R_{θ}=e^{iθσ} where σ represents a Pauli operator (e.g., σₓ, σ_{y}, σ_{z}) and θ is the variational parameter, can be incorporated into the quantum circuits (21). Gradient-based optimization algorithms are applied to update the variational parameters, with quantum gradients estimated using parameter-shift rule. The optimization process includes a forward execution of the quantum circuit, loss evaluation, gradient estimation, and parameter updates. This adaptive optimization loop improves model performance by enabling the quantum circuits (21) to learn task-relevant transformations that are customized to the structure of the input data.

In a preferred embodiment of the invention, the classical computer (C) and/or by the quantum computer (Q) further configured to increasing the accuracy of the sampling results, by establishing following steps:

```
PROCEDURE assign_and_transpile (weights, ansatz, backend)
  IF weights are in tensor format THEN
    CONVERT weights FROM tensor TO NumPy array
  ELSE
    USE weights AS NumPy array directly
  CREATE parameter_dict BY associating each ansatz parameter WITH corresponding
  weights entry
  ASSIGN parameters FROM parameter_dict TO ansatz CIRCUIT to create parameterized
  circuit layer
  COMPOSE parameterized circuit layer INTO the quantum circuit
  TRANSPILE the quantum circuit FOR given backend:
    DECOMPOSE circuit gates with defined repetitions
    APPLY backend-specific optimizations (optimization level set to 2)
    SET a predefined seed for transpilation consistency
RETURN transpiled quantum circuit
```

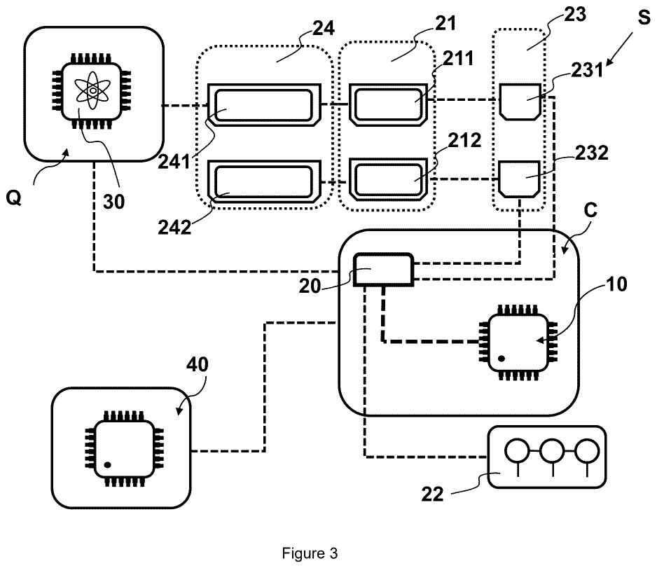

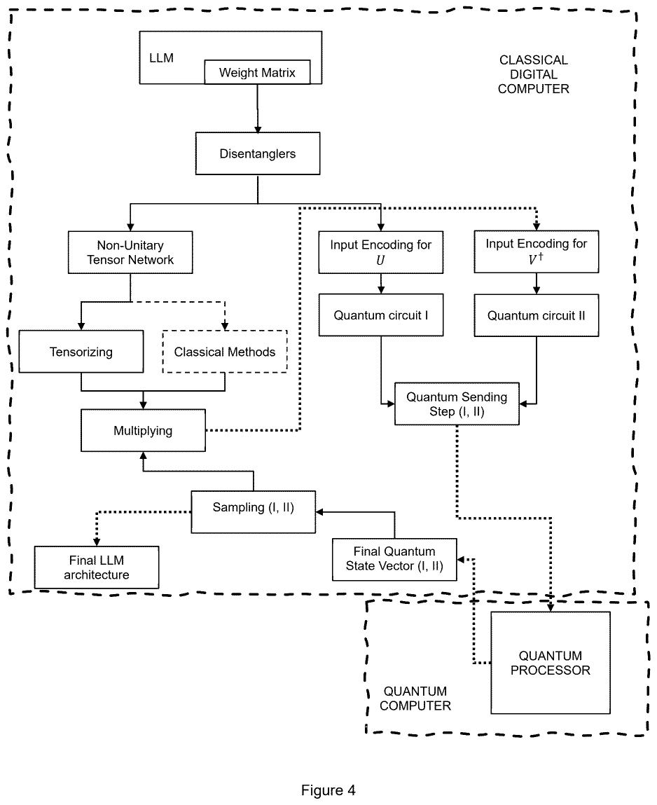

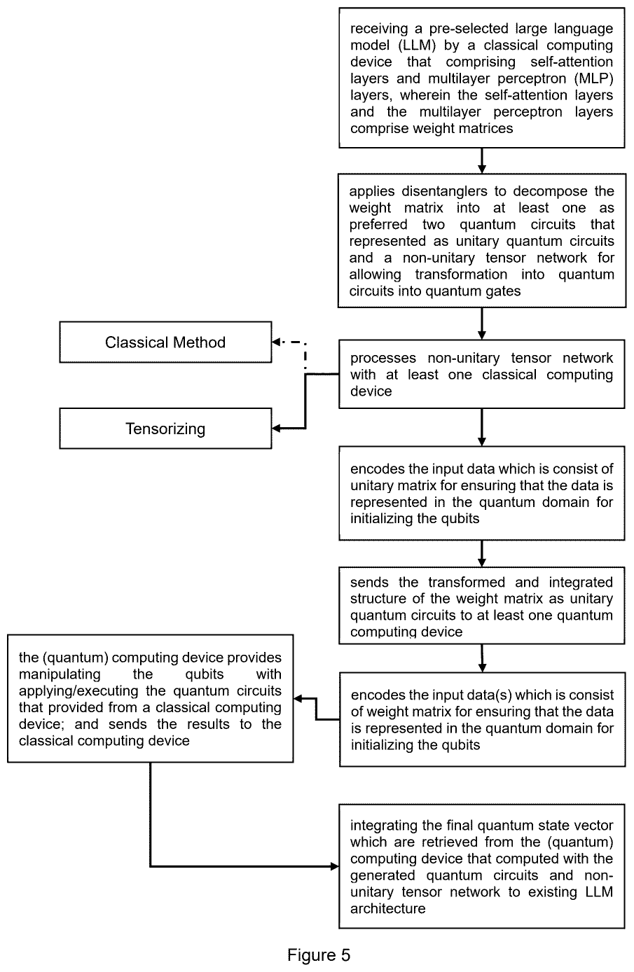

FIG. 3 shows a generic description of a system(S) that runs of the method for some embodiments of the disclosure. In a preferred embodiment of the disclosure; the system(S) for improving the computational efficiency and performance of large language models (LLMs), the system(S) comprising at least one classical computer (C) configured to receive one or more LLM input data, and configured to generating and directing a computational task to at least one quantum computer (Q) over a network, wherein said classical computer (C) comprises at least one digital processor (10) and at least one memory medium (20); wherein said digital processor (10) configured to: receiving a pre-selected large language model (LLM) comprising self-attention layers and multilayer perceptron (MLP) layers, wherein the self-attention layers and the multilayer perceptron layers comprise weight matrices from at least one user or device; applying disentanglers to decompose the weight matrix of the large language model (LLM) into first unitary variational quantum circuits (211), a non-unitary tensor network (22), and second unitary variational quantum circuits (212), respectively, and storing in the memory medium (20); mapping input data received for an LLM input data into a matrix product state (MPS), and encoding the matrix product state (MPS) into a first encoding circuit (231) for initializing the qubits; executing the first unitary variational quantum circuit (211) using the first encoding circuit (231) to apply quantum states of the inputs; sending the first unitary variational quantum circuit (211) with the first encoding circuit (231) to the quantum computer (Q) for receiving a first sampling results; applying the first sampling results of the first quantum execution step to the non-unitary tensor network (22), and constructing a second encoding circuit (232) based on the non-unitary tensor network (22) and the first sampling results; sending the second encoding circuit (232) and the second unitary variational quantum circuit (212) to the quantum computer (Q) for receiving a second sampling results; decoding the second sampling results to provide an output of an LLM input data; wherein the quantum computer (Q) further configured to: manipulating the qubits by executing the first unitary variational quantum circuit (211) with the first encoding circuit (231), and measuring superpositions and entangled states of the qubits multiple times to provide the first sampling results of a quantum state of a first quantum execution step; manipulating the qubits by executing the second unitary variational quantum circuit (212) with the second encoding circuit (232), and measuring superpositions and entangled states of the qubits multiple times to provide the second sampling results of a second quantum execution step.

In a preferred embodiment of the disclosure, the method and system(S), the (quantum) computer section of the method can be made of superconducting qubits, cold atoms, trapped ions, solid state qubits, and photons, being this not a restriction of the disclosure.

According to the disclosed method, can be applied uniformly across all deep layers of the LLM, allowing us to encode existing LLMs into this hybrid classical-quantum architecture.

In a preferred embodiment of the disclosure, the method and system(S), the classical computer (C) that process the tensor network may same device that configures the quantum computer (Q) (initialize the quantum circuits (21)) or one or more classical digital computer (C) can process the tensor networks, this not a restriction of the disclosure.

In various embodiments, the quantum computer (Q) comprises at least one quantum processor (30), which may be implemented using any of a variety of physical platforms capable of supporting quantum computational operations. Examples of such quantum processors (30) include Superconducting Quantum Processors, which exploit superconducting circuits cooled to cryogenic temperatures to maintain coherent quantum states; Photonic Quantum Processors, which utilize photons and integrated optical circuits to perform quantum operations through interference and entanglement; Neutral Atom Quantum Processors, where individual atoms are trapped and manipulated using optical tweezers and controlled via laser pulses; Trapped Ion Quantum Processors, which rely on ionized atoms suspended in electromagnetic fields and operated with high precision laser systems; and Quantum Dot Processors, wherein confined electrons in semiconductor nanostructures serve as qubits with electrically or optically controlled quantum gates. These diverse implementations provide flexibility in the physical realization of the quantum computing system, enabling optimization for specific computational tasks, noise profiles, or integration with classical processing units.

Additionally, the method and system(S) of the present disclosure, the classical computing device may include one or more quantum simulators, e.g., quantum simulator. A quantum simulator is a quantum computer (Q) that may be programmed to simulate other quantum systems and their properties. Example quantum simulators include experimental platforms such as systems of ultracold quantum gases, trapped ions, photonic systems or superconducting circuits.

Additionally, the method and system(S) of the present disclosure, the classical computer (C) or classical digital processor (10) may include one or more classical processors, e.g., classical processor. In some implementations, the one or more classical processors, e.g., classical processor may include supercomputers, or multiple computers working with communication with high levels of computational capacity. For example, the classical processor (10) may represent a computational system with a large number of processors, e.g., a distributed computing system or a computer cluster.

The method and system(S) of the present disclosure can be applicable to any computation system with configurations as set out above. In a preferred embodiment of the disclosure, the method and system, the tensor network section of the method can run on a CPU, a GPU, or an FPGA, being this not a restriction of the disclosure.

### REFERENCE NUMERALS

10. Digital processor
20. Memory medium
21. Quantum circuits
   210. First unitary variational quantum circuit
   211. Second unitary variational quantum circuit
22. Non-Unitary Tensor Network
23. Encoding circuits
   231. First encoding circuit
   232. Second encoding circuit
24. Transpiled circuits
   241. Transpiled first circuit
   242. Transpiled second circuit
30. Quantum processor
C. Classical computer
Q. Quantum computer
S. System

### Definitions in the Disclosure

χ: bond dimension
MPO: Matrix Product Operator
LLM: Large language model
MLP: Multilayer perceptron
ER: Entanglement Renormalization
MERA: Multiscale Entanglement Renormalization Ansatz
W: Weight matrix
MPOold: First (original) Matrix Product Operator
MPOnew: Second (new) Matrix Product Operator (Non-Unitary Tensor Network)
U: Unitary quantum circuits of disentanglers
V: Unitary quantum circuits of disentanglers

1. A method for improving the computational efficiency and performance of large language models (LLMs) by at least one classical computer and at least one quantum computer, the method comprising:
receiving, by the classical computer, an LLM input data, and a pre-selected large language model (LLM), which is stored in a memory medium, comprising self-attention layers and multilayer perceptron (MLP) layers that are deep layers of the large language model (LLM) including at least one weight matrix; wherein the deep layers of the large language model (LLM) are decomposed into a first Matrix Product Operator in a memory medium of the classical computer;
determining, by the classical computer, one or more disentanglers configured to factorize a first Matrix Product Operator (MPO) of the weight matrix into:
a non-unitary tensor network to capture correlations between subsets of tensor components and allow classical simulation and compression by reducing entanglement redundancy and localizing quantum correlations; and
a set of unitary subcomponents comprising a first and second variational quantum circuit, each comprising a plurality of qubits, and configured to execute on the quantum computer by mapping the decomposed subspaces into hardware-efficient quantum gates,
wherein first and second variational quantum circuits configured to execute on the quantum computer in two different quantum execution steps, while execution of the second variational quantum circuit depends on both measurement results of the first variational quantum circuit and the output of the non-unitary tensor network.

2. The method according to the claim 1, further comprising:
storing, by the classical computer, the first and second unitary variational quantum circuits and the non-unitary tensor network in the memory medium (20);
mapping, by the classical computer, input data received for the LLM input data into a matrix product state, and encoding the matrix product state (MPS) into a first encoding circuit for initializing the qubits;
transpiling, by the classical computer, the first unitary variational quantum circuit configured with the first encoding circuit, into a hardware-executable gate sequence by obtaining a transpiled first circuit;
sending, by the classical computer, the transpiled first circuit to the quantum computer;
executing, by the quantum computer, the first transpiled circuit to manipulate the qubits, and measuring superpositions and entangled states of the qubits multiple times to provide first sampling results of a quantum state from a first quantum execution step;
applying, by the classical computer, the first sampling results of the first quantum execution step to the non-unitary tensor network, and constructing a second encoding circuit based on the non-unitary tensor network and the first sampling results;
transpiling the second unitary variational quantum circuit (212), configured with the second encoding circuit, into a hardware-executable gate sequence, obtaining a transpiled second circuit;
sending, by the classical computer, the transpiled second circuit to the quantum computer;
executing, by the quantum computer, the second transpiled circuit to manipulate the qubits, and measuring superpositions and entangled states of the qubits multiple times to provide second sampling results from a second quantum execution step; and
decoding, by the classical computer, the second sampling results to provide output corresponding to the LLM input data.

3. The method according to claim 2, wherein encoding the matrix product state (MPS) into the first and second encoding circuits (231, 232) configured to:
apply parameterized single-qubit rotations U(θ,φ,λ) to a plurality of qubits; wherein each rotation gates are defined by at least one rotation angle about an axis of the Bloch sphere; and
configure a predefined set of entangling two-qubit gates introducing quantum correlations between the qubits.

4. The method according to claim 1, further comprising configuring the classical computer to obtain the first Matrix Product Operator by performing a singular value decomposition (SVD) on the weight matrix of the large language model (LLM) and truncating the bond dimension by retaining a subset of dominant singular values, wherein a truncated result is becomes a compressed Matrix Product Operator with reduced bond dimension.

5. The method according to claim 1, further comprising configuring the classical computer to determine the non-unitary tensor network, first and second unitary variational quantum circuits through the splitting step by approximating the first Matrix Product Operator, referred to as MPO_{old}, stored in the memory medium (20), by encoding it between two sequences of unitary transformations comprising at least two-qubit gates; through a decomposition into:
$${MPO}_{old} \approx U \times {MPO}_{new} \times {V}^{†} ,$$
wherein U and V^{†} are sequences of local unitary transformations implemented as the first and second unitary variational quantum circuits, respectively, and wherein MPO_{new} is a compressed non-unitary tensor network having a reduced bond dimension, representing a disentangled part of the first Matrix Product Operator.

6. The method according to claim 1, wherein the optimization of the first and second unitary variational quantum circuits is performed based on a cost function defined by the normalized overlap between the first MPO and a reconstructed model comprising the first unitary variational quantum circuits, the non-unitary tensor network, and second unitary variational quantum circuits, respectively.

7. The method according to claim 1, wherein the quantum computer is configured to optimizing at least one of the first and second unitary variational quantum circuits by a Variational Quantum Eigensolver (VQE) algorithm to compute an estimate of the system's energy, by an expectation value of a Hamiltonian operator, wherein a set of variational parameters, which associated with the first and second unitary variational quantum circuits, are iteratively updated to minimize a predefined cost function corresponding to a target observable or model reconstruction error, ensuring that the resulting model outperforms the accuracy of an original network layer of the large language model (LLM).

8. The method according to claim 1, wherein sampling during the first and second quantum execution step comprises measuring the qubits at the output of at least one of the first or second unitary variational quantum circuits multiple times in the computational basis, and aggregating the resulting measurement outcomes to construct a probability distribution representative of the quantum state.

9. The method according to claim 8, wherein the number of repeated qubit measurements is selected to achieve a predefined statistical confidence level in the estimated probability distribution, wherein the confidence level being determined, by the classical computer, based on at least one of:
a target fidelity threshold, or
a task-specific accuracy requirement for the large language model (LLM) output.

10. The method according to claim 8, wherein sampling of the first and second quantum execution step performed by the quantum computer comprises measuring the quantum state output by following steps:
executing quantum measurements on transpiled the first or second unitary variational quantum circuit to generate measurement counts;
normalizing the measurement counts into a probability distribution;
converting each probability into corresponding amplitude components of a reconstructed state vector by calculating square roots of the probabilities;
normalizing the reconstructed state vector;
scaling the normalized state vector by a predetermined factor; and
trimming the scaled state vector to retain a predefined number of amplitudes.

11. The method according to the claim 10, wherein sampling of the first and second quantum execution step performed by the quantum computer, configured to increase accuracy by performing the following steps:
converting weight parameters from tensor format to numerical arrays;
assigning these numerical arrays to parameters of an ansatz circuit to form a parameterized quantum circuit layer;
integrating the parameterized quantum circuit layer into a quantum circuit; and
performing transpilation comprising decomposition of circuit gates, applying backend-specific optimizations, and setting a predetermined transpilation seed for consistency.

12. A method according to claim 6, further comprising a variational optimization, including:
adjusting parameters to increase the number of layers in the first and second unitary quantum circuits;
modifying the bond dimension of the non-unitary tensor network positioned after the first and second unitary quantum circuits; and
generating an optimized non-unitary tensor network configured to provide, when integrated into the large language model (LLM), a transformation that enhances model accuracy relative to a corresponding original network layer.

13. A computer program product to carry out the method according to claim 1, comprising instructions which, when the program is executed by the classical computer to provide a configuration to the quantum computer by first and second unitary quantum circuits, first and second encoding circuit.

14. A system for improving the computational efficiency and performance of large language models (LLMs), the system comprising at least one classical computer configured to receive one or more LLM input data, and configured to generating and directing a computational task to at least one quantum computer (Q) over a network, wherein said classical computer comprises at least one digital processor and at least one memory medium, wherein said digital processor configured to:
receive a pre-selected large language model (LLM) comprising self-attention layers and multilayer perceptron (MLP) layers, wherein the self-attention layers and the multilayer perceptron layers comprise weight matrices from at least one user or device; applying disentanglers to decompose the weight matrix of the large language model (LLM) into first unitary variational quantum circuits, a non-unitary tensor network, and second unitary variational quantum circuits, respectively, and storing in the memory medium;
map input data received for an LLM input data into a matrix product state, and encoding the matrix product state into a first encoding circuit for initializing the qubits;
execute the first unitary variational quantum circuit using the first encoding circuit to apply quantum states of the inputs;
send the first unitary variational quantum circuit with the first encoding circuit to the quantum computer for receiving first sampling results;
apply the first sampling results of the first quantum execution step to the non-unitary tensor network, and constructing a second encoding circuit based on the non-unitary tensor network and the first sampling results;
send the second encoding circuit and the second unitary variational quantum circuit to the quantum computer for receiving second sampling results; and
decode the second sampling results by applying quantum state tomography to reconstruct classical vector outputs to provide an output of an LLM input data,
wherein the quantum computer is further configured to:
manipulate the qubits by executing the first unitary variational quantum circuit with the first encoding circuit, and measuring superpositions and entangled states of the qubits multiple times to provide the first sampling results of a quantum state of a first quantum execution step; and
manipulate the qubits by executing the second unitary variational quantum circuit with the second encoding circuit, and measuring superpositions and entangled states of the qubits multiple times to provide the second sampling results of a second quantum execution step.

15. A system according to claim 14, wherein said quantum computer is a simulator for simulating the manipulation of the qubits within the classical computer by executing simulated quantum circuits, which are first and second unitary quantum circuits, first and second encoding circuit that provided by the classical computer.
